(19) United States
(12) Patent Application Publication
(10) Pub. No.: US 2017/0303340 A1
(43) Pub. Date: Oct. 19, 2017

(54) HEATING ROD COMPRISING A HOUSING WITH DIELECTRIC COATING

(71) Applicant: BorgWarner Ludwigsburg GmbH, Ludwigsburg (DE)

(72) Inventors: Katherine O'Sullivan, Co. Kerry (IE); Orla O'Connor, Tralee (IE); William O'Connor, Co. Kerry (IE)

(21) Appl. No.: 15/486,803

(22) Filed: Apr. 13, 2017

(30) Foreign Application Priority Data
Apr. 15, 2016 (DE) 10 2016 107 032.7

(51) Int. Cl. H05B 3/14; H05B 3/46

(52) U.S. Cl. CPC H05B 3/141; H05B 3/46

(57) ABSTRACT

An inventive heating rod is disclosed. The heating rod has a ceramic heating element, a first strip-shaped contact sheet and a second strip-shaped contact sheet. The ceramic heating element is arranged between the first contact sheet and the second contact sheet, and a metal housing is provided in which the heating element and the contact sheets are arranged. The housing is provided with a dielectric coating.

### RELATED APPLICATIONS

This application claims priority to DE 10 2016 107 032.7, filed Apr. 15, 2016, the entire disclosure of which is hereby incorporated herein by reference in its entirety.

### BACKGROUND AND SUMMARY

The present invention relates to a heating rod of the type disclosed in DE 10 2012 107 113 A1. Such heating rods can be used for heating the interior of vehicles, for example.

The present disclosure teaches an improvement in the manufacturing of such heating rods.

The housing of a heating rod according to this disclosure bears a dielectric coating. Thereby, costs for insulation material can be saved and the assembly of the heating rod simplified.

The coating may be applied by spray or dip coating, for example. The coating may be a polymer coating or a ceramic coating. Ceramics are more durable, wear and corrosion resistant, and have higher dielectric strengths than polymers. Possible materials include oxides of aluminum, titanium, and yttrium. The coating should withstand voltages of at least 1 kV. Preferably, the coating can withstand voltages of 3 kV or more. Coatings based on polymers or ceramic can have breakdown voltages of 5 kV or more. Preferably the coating is applied as a mixture of ceramic particles and resin, e.g., as a powder or a liquid. Then the resin is hardened or burnt off by temperatures of up to 200° C. or more.

An advantageous refinement of this disclosure is that the dielectric coating covers an inside of the housing and electrically isolates the contact sheets from the housing. In prior art heating rods, the contact sheets are electrically isolated from the housing by means of isolating strips, e.g., ceramic strips or plastic strips. Such isolating strips are no longer necessary in a heating rod according to this disclosure. Preferably, the contact sheets between which the ceramic heating element or heating elements are arranged to touch the dielectric coating of the housing.

It is also possible to apply the dielectric coating on the outside of the housing. The dielectric layer can then provide an additional safety measure for protecting people from electric shocks. This is especially useful for high voltage heating rods. Fins can be attached to the heating rod, for example by means of an adhesive.

Another advantageous refinement of this disclosure is that the housing comprises a first housing part, which is a profile having an open cross section, and a second housing part closing the open cross section of the first housing part. The two housing parts together form a tube, in which the contact sheets and the ceramic heating element or heating elements are arranged. Applying the dielectric coating to two such housing parts is much easier than applying a dielectric coating inside a tube.

For example, the housing may comprise two profiles that each have an open cross section, e.g., a U-shaped cross section, which is closed by the other profile. Assembling the housing from two identical halves simplifies manufacturing as less different parts are needed. However, it is also possible to use only one profile having open cross section and a flat strip-shaped housing part closing the open cross section of the frost housing part.

The coating can be applied directly onto the metal housing or onto an intermediate layer. An intermediate layer, e.g., a polymer layer, can improve adhesion of the coating.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an exploded view of a heating rod.

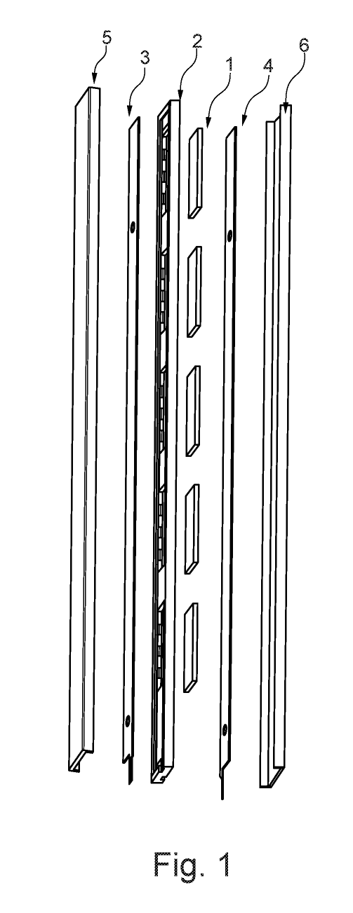

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

The heating rod shown in the attached figure comprises several ceramic heating elements 1 although the heating rod might also be configured with only a single ceramic heating element 1. The ceramic heating elements 1 are resistive heating elements which may be PTC heating elements, for example on the basis of barium titanate.

The heating elements 1 are held in a plastic frame 2 and electrically contacted by a first strip-shaped contact sheet 3 as well as by a second strip-shaped contact sheet 4. As can be seen in the figure, the heating elements 1 are arranged between the strip-shaped contact sheets 3, 4.

The ceramic heating elements 1, the plastic frame 2, and the contact sheets 3, 4 are arranged in a housing. The housing is a metal tube formed by a first housing part 5 and a second housing part 6. The first and the second housing part 5, 6 are profiles which have an open cross section, e.g. a U-shaped cross section. The open cross section of each profile is closed by the other profile when the heating rod is assembled.

The housing parts 5, 6 are provided with a dielectric coating electrically isolating the contact sheets 3, 4 from the metallic housing parts 5, 6. The dielectric coating may be applied by spray coating or dip coating, e.g. as a powder or liquid. If the coating is applied by spray coating, electrostatic coating may be used. The coating may be a ceramic coating or a polymer coating. Such a coating can easily have a breakdown voltage of up to 6 kV or more.

The coating can be applied directly onto a metal surface of the housing. It is also possible to apply the coating onto an intermediate layer that covers the metallic surface of the housing. An intermediate layer can improve adhesion of the coating.

The housing parts 5, 6 may be made of aluminum, for example. The contact sheets 3, 4 may be made of aluminum or copper, for example.

The coating preferably has a thickness of at least 0.10 mm, for example of 100 μm to 180 μm. Thinner or thicker coatings are also possible.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 heating element
2 frame
3 contact sheet
4 contact sheet
5 housing part
6 housing part

What is claimed is:

1. A heating rod, comprising:
a ceramic heating element;
a first strip-shaped contact sheet and a second strip-shaped contact sheet, the ceramic heating element arranged between the first contact sheet and the second contact sheet; and
a metal housing in which the heating element and the contact sheets are arranged;
wherein the housing has a dielectric coating.

2. The heating rod according to claim 1, wherein the dielectric coating has a break down voltage of at least 1 kV.

3. The heating rod according to claim 1, wherein the dielectric coating covers an inside of the housing and electrically isolates the contact sheets from the housing.

4. The heating rod according to claim 3, wherein the first contact sheet and the second contact sheet touch the dielectric coating.

5. The heating rod according to claim 1, wherein the coating is a spray or dip coating.

6. The heating rod according to claim 1, wherein the coating is a ceramic coating.

7. The heating rod according to claim 1, wherein the dielectric coating covers an outside of the housing.

8. The heating rod according to claim 1, wherein the housing comprises a first housing part having an open cross-section and a second housing part closing the open cross-section of the first housing part.

9. The heating rod according to claim 1, wherein the coating has a thickness of at least 0.10 mm.

10. The heating rod according to claim 1, wherein the coating is applied onto an intermediate layer.
